(19) United States
(12) Patent Application Publication
(10) Pub. No.: US 2008/0154656 A1
(43) Pub. Date: Jun. 26, 2008

(54) Data Collection System with Document Production Capability

(76) Inventors: Kevin J. Kail, Great Falls, VA (US); Charles B. Williams, South Riding, VA (US); James M. Blakeley, Stafford, VA (US)

Correspondence Address: JOHN S. HALE;GIPPLE & HALE, 6665-A OLD DOMINION DRIVE, MCLEAN, VA, 22101, US

(21) Appl. No.: 10/589,858

(22) PCT Filed: Feb. 17, 2005
(86) PCT No.: PCT/US05/05213

§ 371 Date: Aug. 17, 2006

(51) Int. Cl. G06F 7/02; G06F 7/00; G06Q 10/00; G06F 17/30

(52) U.S. Cl. 705/7; 707/104.1; 707/103 R; 707/E17.008; 707/E17.143

(57) ABSTRACT

A computer program product, tangibly embodied in an information carrier, for use in a commercial data processing environment using at least one RFID/EPC readers and antennae for data collection. The computer program is able to read and collect tag data as it is read, create business documents for the user from a set of business rules and pre-built business document templates in electronic storage, convert both the business document and the tag data into separate database structures and join the two database structures into a single database structure. The single database structure in converted back into the required business document format.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### FIELD OF THE INVENTION

The present invention generally relates to EPC-compliant tag data and integrating search data using the tag data to produce relevant business documents.

### BACKGROUND OF THE INVENTION

In order to more quickly exchange business documents the Electronic Data Interchange (EDI) was created in the 1960's. EDI was originally an industry vertical effort and was handled with point-to-point direct connections. Early adopters of EDI soon realized that maintaining a large number of point-to-point connections with many trading partners using many computing platforms was very costly. The first value added network (VAN) was born when several industries in the early 1970s sponsored a shared EDI system and turned it over to a third party network. By the 1970's, more and more industries were involved, and work began to institute national and international standards. The goal was to create standards that (1) were hardware independent; (2) were unambiguous and could be used by all trading partners; (3) reduced the labor-intensive tasks of exchanging data (e.g., data re-entry); and (4) allowed the sender of the data to control the exchange, including knowing if and when the recipient received the transaction. Today there are numerous syntaxes for traditional EDI, although only two are widely recognized: X12 and EDIFACT.

In an attempt to make the transactional data of EDI in particular and business documents in general, several more human readable several XML standards were developed. One of these standards was a subset of XML known as Meta-XML. Meta-XML uses the ability of the XML tag structure to contain “attributes” or meta-data which further describes the data or puts the data in context.

As EDI and XML exchanges became more prevalent, the availability of low cost high speed Internet connections made VAN replacement a target for cost savings, just as EDI and XML have lowered costs. This replacement technology had to ensure security and delivery of the data. The result was the Electronic Data Interchange-Internet Integration group (EDIINT). This group like the standards groups of EDI and XML, worked on developing a generally accepted standard for secure transmission of business data over the Internet. The result of this group's work was the AS1 and later AS2 protocols.

AS2 uses an envelope structure with sender and receiver information, which can contain an encrypted payload. To ensure that the transmission was successful an acknowledgement is returned upon completion of the transmission. The AS2's payload can be any document structure; its only constraint is that it be contained in a valid AS2 envelope.

Radio frequency identification (RFID) is becoming an important identification technology in numerous applications such as inventory management, security access, personnel identification, factory automation, automotive toll debiting and vehicle identification. RFID systems utilize an RFID transmitter-receiver unit (usually referred to as a base station or interrogator) to query an RFID transponder or tag which may be located at a distance from the transmitter-receiver unit. The RFID tag which incorporates a chip detects the base station signal and transmits a response signal via an antenna incorporated in the tag containing encoded data back to the base station.

RFID systems provide identification functions not found in other identification technologies such as optical indicia (e.g., bar code) recognition systems. For example, RFID systems may employ RFID tags containing read/write memory of several kilobytes or more. The RFID tags may be readable at a distance and do not require direct line-of-sight view by the base station. Further, multiple RFID tags may be read by the RFID system at one time and specific item identification down to the individual unit can be undertaken using RFID tags. RFID tag reader equipment and associated equipment are commercially available and manufactured by a number of companies.

The breakthrough in RFID technology that allows the creation of electronic product code (EPC) is the conversion of the RFID tag from a database holding the information about the tagged item, to a URL that points to a database. That, together with the Internet, allows the creation and proper function of the EPC.

The RFID network and data storage is separate from the current business networks of EDI and XML business documents. In the past, it was not possible to place all of the information gathered about the tagged items into a usable contextual format. By interconnecting these networks, the present invention provides visibility into the entire supply chain enabling the correlation of the transport of physical products with the documents that are related to the transaction.

### SUMMARY OF THE INVENTION

The present invention employs RFID technology to store and provide information about assets such as items, devices, and products combined with software and apparatus for integrating RFID/EPC tag data with business documents to produce business documents directed toward specific fields of business usage.

RFID/EPC tag data is obtained from a RFID/EPC tag that is attached to an object.

The invention includes a tagging component such as RFID tag manufactured by Texas Instruments, Inc., Matrics, Inc. or Alien Inc. that includes information specifying standards which is applied to all articles to be identified. Each tag includes a globally unique identifier. An object interface component includes one or more devices for communicating with the tags and a device for receiving context information which uses a context-aware intelligence that includes logic for processing context information and logic specifying actions for the system to perform in response to the context information. A communication middleware component is used for communication between and among the components of the system and for communicating with devices external to the system.

The invention can be implemented as a fully deployed system running entirely within a user's computer networking infrastructure or as a hosted service where key components are run on a provider's computer networking infrastructure and only those components readers and the software connected to the readers needed at customer facilities are deployed at the customer's facility.

One aspect of the invention is the use of meta-XML. Meta-XML allows the invention to put into context all business documents that it processes. XML documents have been compared to databases; their tree structure allows easy manipulation of the data because it has a definable location or node within the document. By using meta-XML, the addition of attributes not only places the data in richer context, it also gives each node or location of the data (the xpath) in the document, another level of unique identification. This allows the data to be contextually displayed for machine to human interaction using XML display files (XSL), and more intelligent transformation of the data into other structures using XML transformation files (XSLT).

It is an object of the invention to allow users that have business documents, which contain information about articles being manufactured, maintained in inventory, or sold by one party to another have the articles tagged with a RFID/EPC tag and have these two streams of data (the business documents and the RFID/EPC tag data) integrated into a single stream of data for access and reporting.

It is another object of the invention to provide improvements to inventory management.

It is yet another object of the invention to provide improvements to inventory visibility.

It is another object of the invention to provide improvements to operational improvements.

It is still another object of the invention to provide improvements to inventory shrinkage.

It is yet another object of the invention to provide improvements to asset tracking.

These and other objects, advantages, and novel features of the present invention will become apparent when considered with the teachings contained in the detailed disclosure, which along with the accompanying drawings, constitute a part of this specification and illustrate embodiments of the invention which together with the description serve to explain the principles of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic flowchart showing a system in accordance with the invention;

FIG. 2 is a schematic flowchart showing a technology stack used by the invention;

FIG. 3 is a schematic flowchart showing a drill-down of a software program that implements a communications network for business documents from FIG. 1;

FIG. 4 is a schematic flowchart showing a drill-down of a software program that implements a communications network for RFID/EPC tag data from FIG. 1;

FIG. 5 is a schematic flowchart which shows the flow of a business document without any RFID/EPC tag data;

FIG. 6 is a schematic flowchart which shows the flow of RFID/EPC tag data without any documents; and

FIG. 7 is a schematic flowchart which shows the flow integrating the RFID/EPC tag data with the business documents.

### DETAILED DESCRIPTION OF THE INVENTION

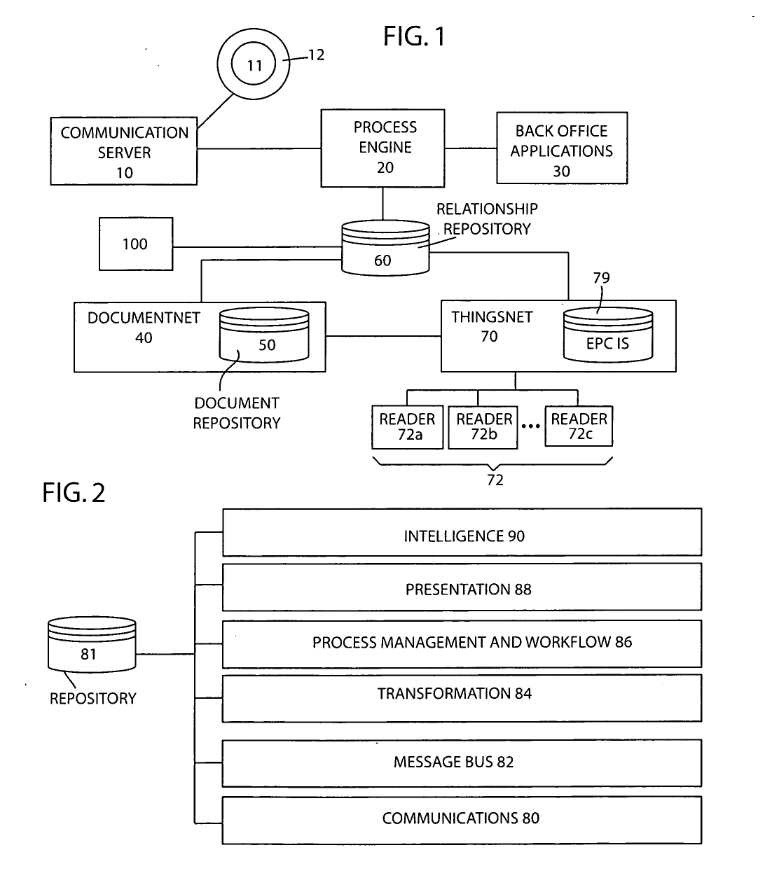

The preferred embodiment and best mode of the invention is shown in FIGS. 1 through 7. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

FIG. 1 discloses the architecture for a system that implements the methods for this invention. The system is constructed with the communication server 10 which is the communications hub of the system for all external communications. External communications occur between the system and interested parties. Interested parties are defined as trading partners (i.e. external businesses) that do business with the entity running the system, SOAP interfaces that provide additional information for the system, or other external communication facilities (e-mail servers, instant message (IM) servers, etc.). When data about an object 11, having an RFID tag which is read by reader 12 or document data, is received via the communication server 10, that object data is passed on to the process engine 20.

The process engine 20 is the central nervous system. It provides core processing for all machine to machine and machine to human data events that occur within the system. Through a series of prescribed rules defined for handling each event, the process engine 20, upon receiving an event, determines the context of the event, what other actions have to take place given the current event and then causes those actions to be executed. The prescribed rules are specifically directed toward the conduct of specific business and the requirements for same. As an example, in a normal retail commerce application the process engine manages the flow of orders, invoices, ship notices, etc. and the alerts and notifications associated with the business documents.

The back office applications 30 are external computer systems that stores or provide data needed by the system. Examples of such back office applications 30 are SAP, JD Edwards, Oracle and EDI Translators. The back office applications 30 send and receive data to/from the process engine 20.

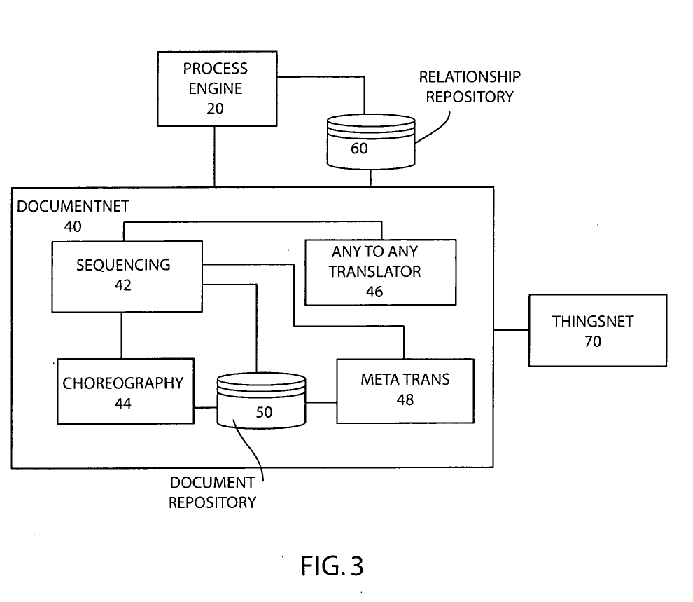

The business document data network (BDDN) 40 is the component responsible for managing all of the business documents that flow through the system. The BDDN 40 is the equivalent of a PBX for voice or a Cisco router for data. It is programmable and configurable to the defined needs of the entity or user of the system. It can be programmed and configured to support various display devices (web browser, PDA, cell phone, etc.), various communications protocols (AS/2, HTFP, FTP, etc.) and to handle any process required by the business documents that it processes. The process engine 20 invokes the BDDN 40 whenever a business document is received via the communication server 10 or back office applications 30. The BDDN 40 is responsible for and manages document translation, document sequence and document choreography involved in an overall business transaction that is being managed by the system. These functions are shown in detail in the FIG. 3. The BDDN 40 contains a document repository 50 that is used to store electronic representations of all documents processed by the system.

FIG. 3 shows a schematic of the BDDN 40 which is responsible for all document processing within the system. The major subcomponents of the BDDN are the sequencing engine software 42 which is a software subsystem that manages the flow of business documents based on a predefined sequence, a choreography engine 44 which is a software subsystem that controls the additional business document sequences based on the business document flow (i.e. when an order is accepted by a supplier, a shipping order needs to be sent to the shipper who will transport the goods from the supplier to the buyer), an any to any translator 46 and a dynamic EDI to XML translator 48.

The sequencing engine 42 controls the sequence of documents required for a defined business transaction. For example, in the retail industry, two trading partners, a buyer and a supplier would agree that when the buyer sends the supplier a purchase order, the supplier will respond with a purchase order acknowledgement. Then, if the two parties agree that changes to an order are allowed, the buyer would send the supplier a purchase order change and the supplier would return a purchase order change acknowledgement. The supplier then sends the buyer an advance ship notice to let the buyer know that the goods for the order are being sent, the supplier sends the buyer an invoice and the buyer completes the conversation by sending back a remittance advice. The sequencing engine 42 is software responsible for managing this transaction and automatically creates the response documents as well as pre-creates templates for any future documents in the transaction. For example, once a purchase order is received, sometime in the future an advance ship notice will be required. The sequencing engine pre-creates a template for this document and stores the template in the document repository 50. At the time the sequenced document is ready to be sent, the template is retrieved from the document repository, completed and then sent to the buyer.

The choreography engine 44 is responsible for spawning additional transaction documents based on the rules defined for a specific trading partner. The rules for spawning additional transaction documents are stored in the relationship repository 60. When a document is sent or received, the choreography engine 44 checks the relationship repository 60 to determine if any additional transaction documents are needed and automatically generates the documents required. Using the purchase order example from above, the supplier knows as soon as it accepts and acknowledges a purchase order that the goods ordered will have to be shipped. In this case, when the purchase order acknowledgement document is sent from the supplier back to the buyer, the choreography engine 44 would determine based on the specific business trading rules defined in the software that (1) a shipment order needs to be placed with the supplier's transportation company, (2) the document is generated and (3) the document is passed to the process engine 42 to be sent to the transportation company.

When the business document requires RFID/EPC tag data to be inserted, the BDDN 40 calls the EPC tag data network 70 to retrieve the necessary RFID/EPC tag data as it is read.

There are two subcomponents that provide translation capabilities for business documents. The any to any translator 46 can take any business document and convert it into any other format. For example if SAP is being used as a back office application 30, then when an EDI document that has information required to be stored in SAP arrives, the any to any translator 46 would convert that EDI document to SAP's IDoc format. The IDoc is then passed directly to SAP and the SAP database is updated.

The EPC tag data network 70 (also referred herein to as thingsnet 70) is the component responsible for managing all of the RFID/EPC tag data and information associated with those RFID/EPC tags. RFID/EPC tag data is collected from readers 72. Multiple readers 72a-c may be attached to the EPC tag data network. ThingsNet contains an EPC information service (IS) repository 74 that is used to store all of the RFID/EPC tags data as well as all the data associated with those tags.

The relationship repository 60 and associated relationship manager 100 stores the information related to all the entities participating in the system. These entities include trading partners, RFID/EPC readers 72, 72a and 72b, back office applications 30 and any other interested party. The relationship repository 60 stores data and meta data (data structures about the data) for all components of the system. All components of the system thereby access the same set of information whenever it is needed during the processing of events and actions.

FIG. 2 shows the network stack used to implement the invention. At the lowest level is the communications layer 80. This layer handles the lowest level communications protocols with both external and internal entities. The communications protocols supported are any communication protocols required by the user and its trading partners, including but not limited to such protocols as HTTP(S), TCP/IP, X.25 and AS/2. All of the internal communication protocols are IP based, that is HTTP, TCP/IP, etc.

A message broker bus 82 is the internal communications infrastructure. It is used to route information between all components in the system. The message broker bus 82 supports both synchronous and asynchronous communications as needed between components.

The transformation engine 84 is responsible for translating data between the various different formats required for a conversation involving documents and RFID/EPC tag data. For example, if a document is received as an EDI document, but information in that document is used to update a back office application, the back office application requires the information to be in a format explicit to that application. The transformation engine 84 has the responsibility for performing that translation based on the rules defined in the repository 81 for the data format required by the back office application. The repository 81 holds all persistent and transient data, documents, rules, EPC tag data, etc. that the system generates, requires, or consumes during normal operations. The repository 81 combines the relationship repository 60, EPC IS 79 and document repository 50.

The process management and workflow component 86 is the overall controller of the system. The process management and workflow component 86 manages all machine to machine processes needed for interaction between all the parties involved in an implementation of the system. Workflow, which is subservient to process management, provides an implementation of the machine to human aspects of an implementation of the system. When the process manager detects an error or alert condition, it invokes the workflow manager to route that error or alert to a designated human for resolution. If the error or alert is not handled in a timely manner, the workflow engine consults the rules in the repository 81 to determine proper escalation procedures for the error or alert. The process manager may also invoke the workflow engine in the case where a human is required to make a decision as a normal part of the process.

The presentation component or layer 88 is responsible for converting all data for human display on an as-needed basis. The presentation layer provides personalization features for all human users of the system. The personalization can be done based on display preferences (color, logo, etc.) or on device preferences (web browser, PDA, cell phone, etc.).

The intelligence component or layer 90 provides both business and process intelligence to users of the system. Business intelligence allows the user to view pre-defined or ad-hoc reports about the user's business. For example, “What is my current inventory level?”, “How many orders need to be filled today?”, etc. Process intelligence allows the user to view pre-defined or ad-hoc reports about the processes being run and managed by the system. For example, “How many orders are currently being filled?”, “How many documents are being processed?”, etc.

The repository 81 stores all the information related to all the entities participating in the system. These entities include trading partners, RFID/EPC readers, back office applications and any other interested party, documents, RFID/ECP tag data, etc. The repository 81 stores data and meta data (data structures about the data) for all components of the system. All components of the system thereby access the same set of information whenever it is needed during the processing of events and actions.

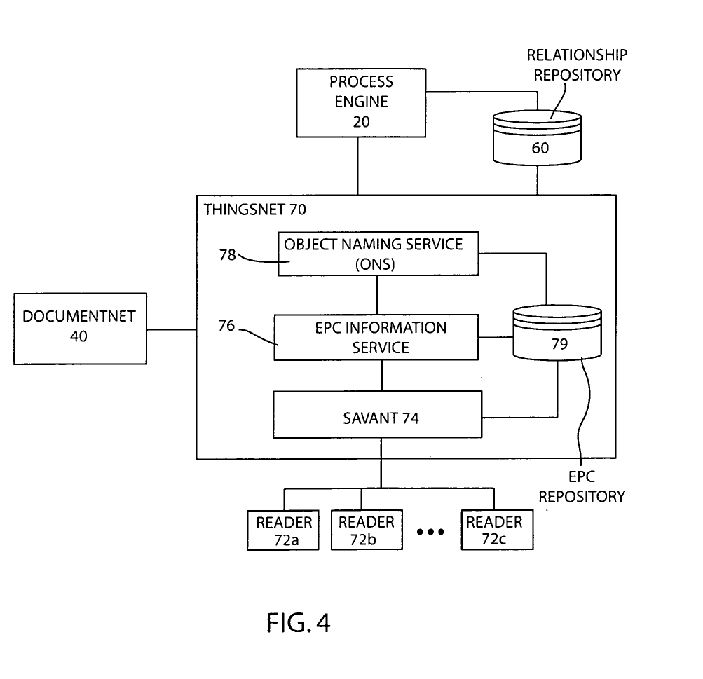

FIG. 4 shows a schematic flowchart of the EPC tag data network 70 component of the system. The EPC tag data network component is based on the RFID/EPC standards and specifications as defined by EPCglobal, Inc. The subcomponents of EPC tag data network are RFID/EPC readers 72, savant 74, EPC information service (EPC IS) 76, object naming service (ONS) 78, and the EPC IS repository 79.

The savant 74 is the core component and provides a set of middleware services for communicating between the readers 72 and other external applications. The savant 74 provides an application programming interface (API) which allows external applications to invoke its services to either initialize RFID/EPC tags or to retrieve the RFID/EPC tag data that has been collected by the readers.

The EPC information service 76 provides an application programming interface (API) to create, read, update, and delete data associated with RFID/EPC tags. The EPC IS 76 maintains the relationship between the RFID/EPC tag data and the meta data about the article that the RFID/EPC tag is attached to. For example, when an RFID/EPC tag is attached to a manufactured item (for example, a case of motor oil) the system associates the RFID/EPC tag with the information about the manufactured item and stores it in the EPC IS repository 79 via the EPC IS 76. Later in the process, when information about a tagged item is needed, that information is retrieved from the EPC IS repository 79 via the EPC IS 76.

The object naming service (ONS) is to RFID/EPC tag data what a domain name service (DNS) is to computers connected to the Internet. When a system needs to locate a computer on the Internet it sends a request to a DNS. The DNS performs a lookup in the DNS repository and send the result of that lookup back to the requesting system. Similarly, when the system described in this invention requires information about a RFID/EPC tag that is not resident in its local EPC IS repository, it sends a query to the ONS which performs a lookup in the ONS repository to locate the EPC IS that has the information about the tag. The system then uses that EPC IS location information to invoke a query against the provided EPC IS to retrieve the desired data.

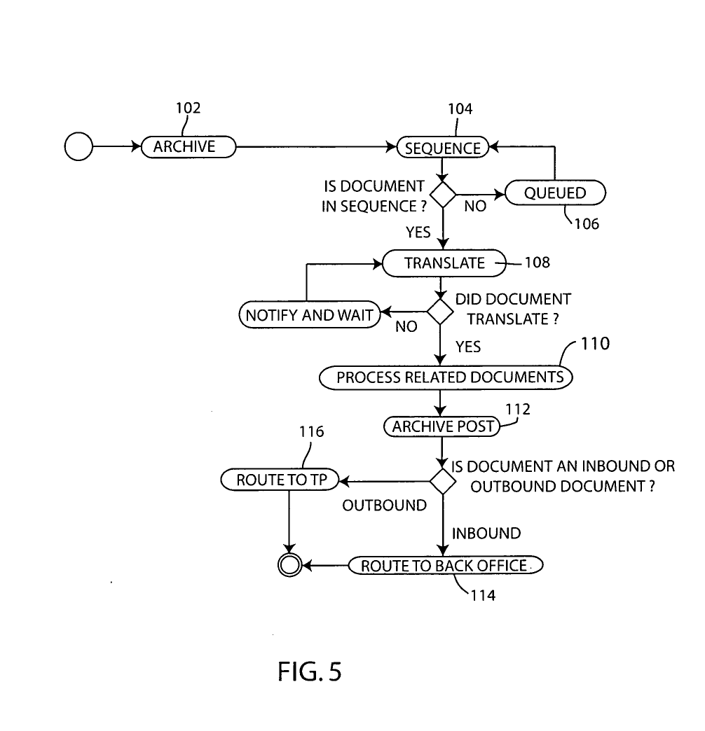

The remaining FIGS. 5-7 provide details on the flow of information through the system for documents, RFID/EPC tag data and documents integrated with RFID/EPC tag data. Current best practices maintain a separation between business documents and RFID/EPC tag data. That is each (tag data, documents) data is treated as a separate stream of information. When correlation between the two is needed a computer system is used to check that the business document matches the RFID/EPC tag data. The purpose of this invention is to provide methods and computer systems that implement those methods for integrating business documents and RFID/EPC tag data. Businesses that implement this methodology can gain substantial cost savings throughout their supply chain.

The flow chart in FIG. 5 shows the separate flow for processing business documents. When any document is received, the first step in the process is to archive 102 that document for legal and historical purposes. Following that, the sequence engine 104 checks to make sure the document is in sequence for the business communication that the document relates to. If the document is not in sequence it is queued 106 until such a time when all other preceding documents in the business communication have been processed. If the document is in sequence, the next step is to translate 108 the document according to the business rules stored in the relationship repository for that document.

Following successful translation the choreography engine is called to process any additional related document 110. Next, the translated version of the document is archived 112 and then the document is routed to the appropriate location. The appropriate location is determined by the document type and the rules setup for that document type and trading partners. If the document is an inbound document it is routed to the appropriate back office system 114. If the document is an outbound document it is routed to the receiving trading partner 116. If the document is not successfully translated, a machine to human action is invoked (workflow) to notify the appropriate person of the failure so that the problems can be corrected and the document successfully translated.

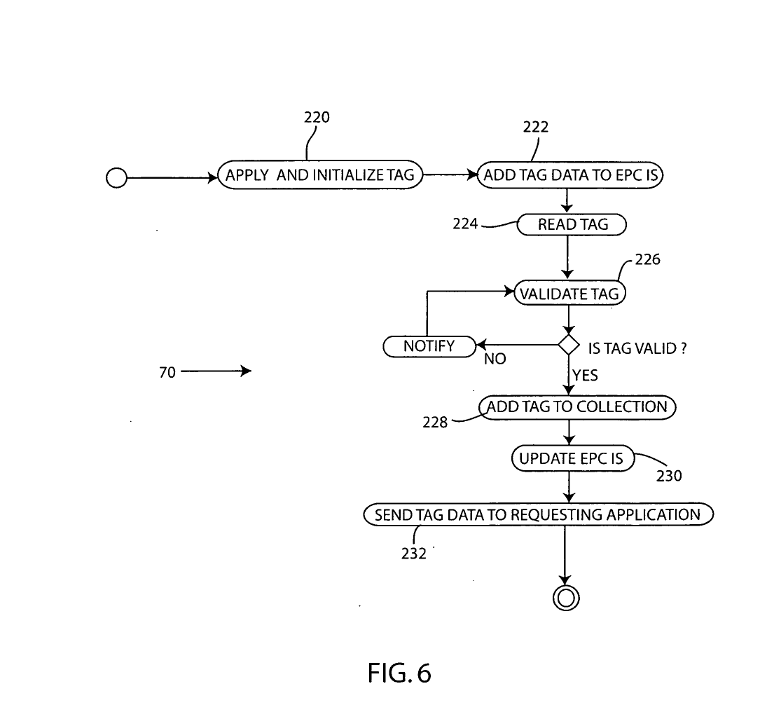

For the EPC tag data network 70, which is shown in the flowchart of FIG. 6, the flow of information starts when an RFID tag is applied to an object 11 and the tag is initialized 220 with the appropriate tag data 222. This tag data is then stored in the EPC information service database. Any time the tag passes through a tag reader (12) 224, the tag is validated 226 to ensure it is an authentic tag that as well as checking what the tag is attached to. If the tag is valid, it is then added to a collection 228 based on its location. For example, if the tag is applied to a case of goods and that case is placed on a tagged pallet, the EPC information service database 230 is updated with this information. Finally, this EPC tag data information is supplied to requesting applications 232 on request.

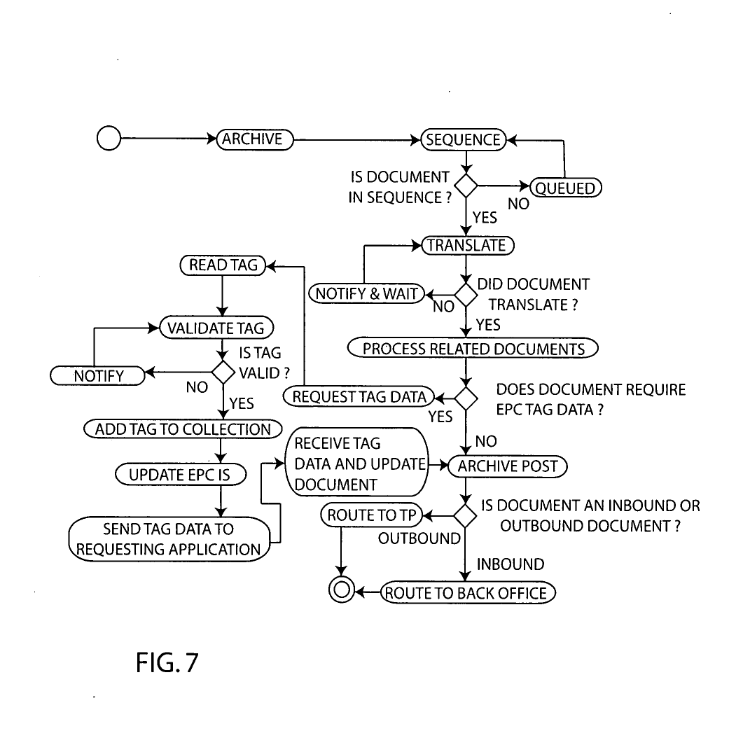

The inventive integration of the document flow with the EPC tag data flow as is shown in the flowchart shown in FIG. 7. This process allows the business documents and the EPC tag data that relates to the business documents to be integrated into a single stream of data. This integrated stream of data provides a complete audit trail from the business document to the physical goods associated with those business documents. The integrated process follows the document-only process until the related documents are processed. Then, instead of archiving the translated document, the relationship manager is queried to determine if EPC tag data needs to be embedded in the document. If it is determined that the EPC tag data should be embedded, the EPC tag data process is invoked to collect the required EPC tag data, the data is returned to the requesting application, in this case the business data document network (BDDN), and the EPC tag data is inserted into the proper location in the respective document.

The integrated process begins with a document being sent from one trading partner to the user of the system. As in the BDDN, the document is first archived and then checked to ensure that it has been received in the proper sequence as defined in the relationship manager database. Once the sequence check passes, the document is translated. If the translation fails, the document is queued and a notification is sent to correct the problem that is causing the translation failure. Once the document is translated into the proper format, the relationship manager is checked to determine if additional documents need to be generated. This is handled by the choreography engine. The translated document and any additional documents are checked against the database to determine if they can accept EPC/RFID tag data. If the document(s) can accept the EPC/RFID tag data, the EPC tag data network is called so the tag data relating to the specific document can be collected. As the EPC/RFID tags are read by the reader and processed by the EPC tag data network, the information is provided back to the BDDN and the received EPC/RFID tag data is inserted into the proper location in the document. Control is then passed back to the BDDN, which archives the new document structure (with embedded EPC/RRID tag data), the actions are logged and the document is delivered to the destination trading partner via the agreed protocol.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present inventions defined by the following claims.

What we claim is:

1. A computer program product, tangibly embodied in an information carrier, for use in a commercial data processing environment using at least one RFID/EPC readers and antennae for data collection, the computer program being able to read and collect tag data as it is read, create business documents for the user from a set of business rules and pre-built business document templates in electronic storage, convert both the business document and the tag data into separate database structures, join the two database structures into a single database structure and convert the single database structure back into the required business document format.

2. The computer program product of claim 1 wherein the computer program product is further operable to: send and receive business documents in any format (EDI, XML, flat file, etc.) either with or without the integrated RFID/EPC tag data.

3. The computer program product of claim 1 wherein the computer program product retroactively inserts the matching RFID/EPC tag data related to the document.

4. The computer program product of claim 1 wherein the tags are radio frequency identification (RFID) tags, each RFID tag carrying an electronic product code (EPC) as the unique tag identifier.

5. The computer program product of claim 1 wherein the computer program product is further operable to: display the integrated business documents with RFID/EPC tag data in a human-readable format to any display device.

6. The computer program product of claim 1 wherein said display device is a web browser.

7. The computer program product of claim 1 wherein said display device is a wireless PDA.

8. The computer program product of claim 1 wherein said display device is a cell phone.

9. The computer program product of claim 1 wherein the computer program product is further operable to: properly sequence all operations within the scope of both external (Business to Business) and internal business conversations and operations including all defined events between multiple parties.

10. The computer program product of claim 9 wherein said sequencing allows the computer product to control all interactions between external systems internal systems and internal or external people involved in completing the defined business events.

11. A document production system for objects identified by an RFID tag containing an electronic product code as the unique tag identifier comprising computer means to receive object identification data and compare object identification data over the internet with stored meta data pertaining to the object, and retrieve said meta data from an external source, a document repository data base containing business documents relating to the object for specific businesses and means to insert object data taken from said meta data into a plurality of business documents to create object specific business documents.

12. A document production system as claimed in claim 11 including a plurality of readers to read said objects RFID tag and transmit identification data to said computer means.

13. A document production system as claimed in claim 11 wherein said business documents are taken from a group consisting of orders, order acknowledgements, order confirmations, shipping notices, shipping receipts, invoices and maintenance advice.

14. A document production system as claimed in claim 11 wherein said stored meta data is provided by an external computer system.

15. A document production system as claimed in claim 13 wherein a choreography engine creates additional transaction documents based on the rules defined for a specific trading partner.

16. A document production system as claimed in claim 11 wherein said document repository data base includes a translator which can take any business document and convert it into any format.

17. A document production system for objects identified by an RFID tag containing an electronic product code as the unique tag identifier comprising at least one reader to read said objects RFID tag and transmit identification data to a computer means, said computer means receiving object identification data from said RFID tag and comparing object identification data over the internet with stored meta data provided by an external computer system pertaining to the object and retrieving said meta data from said external source, a document repository data base containing business documents taken from a group consisting of orders, pick lists, acknowledgements, confirmations, shipping notices, shipping receipts, inventory records, invoices and maintenance advice, and means to insert object data taken from said retrieved meta data into at least one business document to create an object specific business document.

18. A document production system as claimed in claim 17 including a choreography engine which creates additional transaction documents based on the rules defined for a specific trading partner.

19. A document production system as claimed in claim 17 wherein said document repository data base includes a translator which can take any business document and convert it into any format.

20. A document production system as claimed in claim 17 wherein said meta data is meta-XML.
